(19) United States
(12) Patent Application Publication
(10) Pub. No.: US 2017/0220117 A1
(43) Pub. Date: Aug. 3, 2017

(54) CONTROL DEVICE AND METHOD FOR A MOTOR VEHICLE

(71) Applicant: DAV, Créteil (FR)

(72) Inventors: Stéphanie Dabic, Créteil (FR); Nour-Eddine El-Ouardi, Créteil (FR)

(73) Assignee: DAV, Créteil (FR)

(21) Appl. No.: 15/514,943

(22) PCT Filed: Oct. 2, 2015
(86) PCT No.: PCT/FR2015/052656

§ 371 Date: Mar. 28, 2017

(30) Foreign Application Priority Data
Oct. 2, 2014 (FR) 1459457

(51) Int. Cl. G06F 3/01; G06F 3/041; B60W 50/16

(52) U.S. Cl. CPC G06F 3/016; B60W 50/16; G06F 3/0412; G06F 3/0414; G06F 3/0416; B60W 2050/143

(57) ABSTRACT

The invention relates to a control device for a motor vehicle, comprising: a tactile surface (2) for detecting the contact of the finger of a user and the movement of the finger on the tactile surface; and a haptic and/or acoustic feedback module (4) designed to make the tactile surface (2) vibrate and/or to generate an acoustic feedback for the user, in response to contact on the tactile surface (2); characterised in that it comprises a management unit (5) designed to manage the haptic feedback and/or acoustic feedback module (4) in order to generate a haptic and/or acoustic feedback pattern when a movement of the finger is detected on a border (6) separating two areas (Z1, Z2) of the tactile surface (2). The invention also relates to a control method.

The present invention relates to a control device for a motor vehicle and a method for controlling said control device.

In recent years, cars have become easy to handle with the appearance of new emergent technologies (for example, assisted steering, ABS, speed regulator, reversing radar, etc.). Paradoxically however, the number of functions to be controlled while driving has also increased considerably. That can lead to a certain complexity associated with the poor knowledge of the use of these functionalities and their diversity. The car has become a true living space, perceived as a personal and interconnected communication centre: with, for example, the MP3 player, GPS, connection with cell phones.

The introduction of these new functions is reflected by an increase in the number of buttons on the dashboard of a car interior. However, the number of buttons cannot be increased ad infinitum, particularly because of the resulting complexity, the limited space, the accessibility or the cognitive load. Furthermore, the interaction of the driver with the systems embedded in the car can reproduce a situation of attention overload in which the driver cannot best deal with all the information concerning the task of driving, that being reflected by errors and longer detection times.

One possibility is to centralize the buttons by replacing them with a touchscreen. This makes it possible to continue to increase the number of the functions, the latter becoming programmable and reconfigurable and displayed temporarily or permanently depending on the context or the function activated. The screen thus includes a multifunctionality capability, while dematerializing the buttons and being customizable. Furthermore, the screens have three other major advantages: they allow on the one hand a direct interaction (the colocation of the display and input), and on the other hand they are versatile (the display can be easily configured for a certain number of functions), and finally they are intuitive (interaction method that is familiar, such as a “pointer” for example).

However, contrary to the case of a pushbutton, when the driver interacts with the touchscreen, he or she does not receive any feedback linked directly to his or her action on the interface, other than the simple contact of his or her finger rubbing on the screen.

In order to compensate for the loss of information caused by the replacement of conventional mechanical interfaces by touchscreens, provision is made for feedback, such as haptic feedback, to be added to provide the user with feedback from the system. This feedback makes it possible to avoid the possible ambiguity concerning the recognition of the action of the user by the system, which can favour the occurrence of hazardous situations. It must however also avoid overloading the visual and auditory pathways already highly stressed by the task of driving. In effect, the use of touchscreens in a motor vehicle must not divert the attention of the driver.

One aim of the present invention is to provide a control device and a method for controlling said control device, which does not hamper the driving, which is well perceived and appreciated by the users, and which can be discriminated from the other signals for a touchscreen application that observes motor vehicle constraints.

To this end, the subject of the present invention is a control device for a motor vehicle comprising:
a touch surface intended to detect a contact of a finger of a user and the movement of the finger on the touch surface, and
a haptic and/or audio feedback module configured to make the touch surface vibrate and/or to generate audio feedback to the user, in response to a contact on the touch surface,
characterized in that it comprises a driver unit configured to drive the haptic and/or audio feedback module so as to generate a haptic and/or audio feedback pattern when movement of the finger is detected across a boundary separating two zones of the touch surface.
What is meant by a boundary separating two zones is a predefined boundary or limit on the touch surface determined for example by the computer or software program loaded into the control unit. This then is a boundary defined by software rather than a boundary that is physical or identified by markings.

It is thus possible, using the haptic and/or audio feedback, to simulate a physical boundary or a limit between two zones even though the touch surface has no such physical boundary and is generally completely smooth.

According to one or more features of the control device, taken alone or in combination,
no haptic feedback is generated once the finger has crossed the boundary,
the touch surface comprises at least one first zone delimited by a closed surface, and at least one second zone surrounding said first zone.
It is thus possible for example to simulate a keyboard key.
a first haptic and/or audio feedback is generated when a movement of the finger into the first zone delimited by a closed surface is detected, and a second haptic and/or audio feedback is generated when a movement of the finger out of said first zone is detected. It is possible to simulate what a user feels when pressing and then releasing a key,
the second haptic and/or audio feedback is distinct from the first haptic and/or audio feedback,
the driver unit controls a function when contact is detected in the zone situated behind the boundary,
a parameter of the audio feedback is chosen from the intensity of the volume, the phase, the frequency, the duration and/or a parameter of the haptic feedback is chosen from the intensity of the acceleration, the frequency, the amplitude, the duration, the phase.

Another subject of the invention is a method for controlling a control device for a motor vehicle as described previously, characterized in that it comprises the following steps:
a contact of a finger of a user and the movement of the finger on the touch surface are detected, and
a haptic and/or audio feedback is generated when a movement of the finger is detected over a boundary separating two zones of the touch surface.

According to one or more features of the control method, taken alone or in combination,
no haptic feedback is generated once the finger has crossed the boundary,
the touch surface comprises at least one first zone delimited by a closed surface, and at least one second zone surrounding said first zone,
a first haptic and/or audio feedback is generated when a movement of the finger into a first zone is detected, and a second haptic and/or audio feedback is generated when a movement of the finger out of said first zone is detected,
the second haptic and/or audio feedback is distinct from the first haptic and/or audio feedback,
the driver unit controls a function when contact is detected in the zone situated behind the boundary.

### BRIEF DESCRIPTION OF THE DRAWINGS

Other advantages and features will emerge on reading the description of the invention, and the attached figures which represent a non-limiting exemplary embodiment of the invention and in which:

FIG. 1 represents an example of a control device for a motor vehicle, and

FIG. 2 represents an example of a touch surface.

In these figures, identical elements bear the same reference numbers.

### DETAILED DESCRIPTION

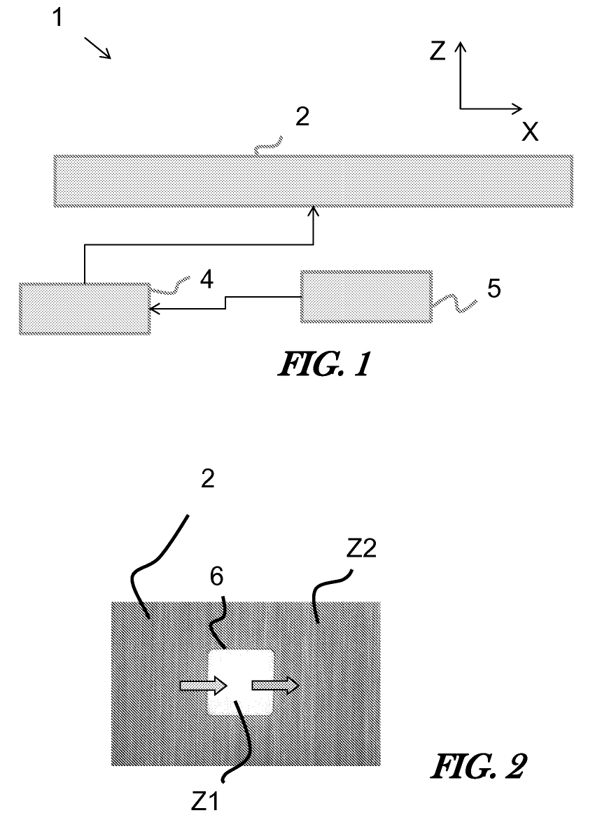

FIG. 1 represents a motor vehicle control device 1.

The control device 1 comprises a touch surface 2 and a haptic and/or audio feedback module 4.

The touch surface 2 is intended to detect a contact of a finger of a user and the movement of the finger over the touch surface 2.

The haptic and/or audio feedback module 4 is configured to make the touch surface vibrate in response to a contact on the touch surface 2 by a finger or any other activation means (for example a stylus) of a user having for example modified or selected a command and/or to generate an audio feedback to the user in response to a contact on the touch surface 2.

“Haptic” describes a feedback by touch. Thus, the haptic feedback is a vibratory or vibrotactile signal.

The control device 1 can comprise a display device arranged under the touch surface 2 to display images through the touch surface 2, which is then transparent, thus forming a touchscreen.

A touchscreen is an input peripheral device enabling the users of a system to interact therewith by virtue of touch. It allows the direct interaction of the user on the zone that he or she wants to select for various uses such as, for example, the selection of a destination address or of a name in a directory, the settings of the air condition system, the activation of a dedicated function, the selection of a track from a list, or, generally, scrolling through a list of choices, selection, validation, and errors.

The touch surface 2 comprises a plate bearing a contact sensor for detecting a push pressure or a movement of the finger or of a stylus of the user.

The contact sensor is for example a pressure sensor, typically using the FSR (Force Sensing Resistor) technology, that is to say using pressure-sensitive resistors. The FSR technology exhibits a very good strength and robustness, while having a high resolution. Furthermore, it is highly reactive and accurate, while being relatively stable over time. It can have a fairly long life, and can be used with any type of activation means, at a relatively low cost.

According to one design of the FSR technology, the sensor operates by placing two conductive layers in contact for example by the action of the finger. One of the embodiments consists in covering a glass plate with a layer of conductive ink, on which is superposed a sheet of flexible polyester, which is itself covered on its inner face by a layer of conductive ink. Insulating and transparent blocks insulate the plate from the polyester sheet. The activation on the touch surface produces a light depression of the polyester layer, which comes into contact with the conductive layer of the glass plate. The local contact of the two conductive layers results in a modification of the electrical current applied to the plate, corresponding to a voltage gradient.

According to another example, the contact sensor comprises flexible semiconductive layers sandwiched between, for example, a conductive layer and a resistive layer. By exerting a pressure or a dragging action on the FSR layer, its ohmic resistance decreases thus making it possible, by application of an appropriate electrical voltage, to measure the pressure applied and/or the location of the point where the pressure is exerted.

According to another example, the contact sensor is based on a capacitive technology.

The haptic feedback module 4 comprises at least one actuator (not represented) linked to the plate of the touch surface 2, to generate the haptic feedback as a function of a signal from the contact sensor. The haptic feedback is a vibratory signal such as a vibration produced by a sinusoidal control signal or by a control signal comprising a pulse or a succession of pulses, sent to the actuator. The vibration is for example directed in the plane of the touch surface 2 or orthogonally to the plane of the touch surface 2 or even directed according to a combination of these two directions.

In the case of a plurality of actuators, the latter are arranged under the touch surface 2, in different positions (at the center or on one side) or in different orientations (in the direction of the press on the surface or in another axis).

According to an exemplary embodiment, the actuator is based on a technology similar to the loudspeaker (voice coil) technology. It comprises a fixed part and a part that is translationally mobile in an air gap of the fixed part, for example of the order of 200 μm, between a first position and a second position, parallel to a longitudinal axis of the mobile part. The mobile part is for example formed by a mobile magnet sliding in a fixed coil or by a mobile coil sliding around a fixed magnet, the mobile part and the fixed part cooperating by electromagnetic effect. The mobile parts are linked to the plate in such a way that the movement of the mobile parts generates the translational movement of the plate to generate the haptic feedback to the finger of the user. This technology is easy to control and allows the displacement of great masses, like that of a screen, at various frequencies and observes the very strict motor vehicle constraints that are a low cost, a good resistance to high temperature variations, and simplicity of installation.

The control device 1 further comprises a driver unit 5 configured to drive the haptic and/or audio feedback module 4 so as to generate a haptic and/or audio feedback when movement of the finger is detected across a boundary 6 separating two zones Z1, Z2 of the touch surface 2.

Of course, the boundary 6 is not physically embodied on the touch surface 2. The movement of the finger, such as a sliding, contains the information regarding the location of the finger at at least two successive spatial coordinates on the touch surface 2.

A parameter of the audio feedback can be chosen from the intensity of the volume, the phase, the frequency, the duration.

A parameter of the haptic feedback can be chosen from the intensity of the acceleration, the frequency, the amplitude, the duration, the phase.

A physical boundary between two zones can thus be simulated using the haptic and/or audio feedback. The boundary for example takes the form of a line, for example at least partially rectilinear. Provision may further be made for no haptic feedback to be generated once the finger has crossed the boundary 6. Provision may also be made for the driver unit 5 to control a function, for example to control vehicle on-board systems such as the air conditioning, radio, music, telephone, ventilation or navigation system when contact is detected inside the zone Z1 situated behind the boundary 6 is detected.

According to an exemplary embodiment depicted in FIG. 2, the touch surface 2 comprises at least a first zone Z1 delimited by a closed surface, for example substantially square, and at least one second zone Z2 surrounding the first zone Z1. Provision may also be made for the driver unit 5 to control a function when contact is detected inside the closed zone Z1. It is thus possible for example to simulate a keyboard key. Thus, when the finger of the user crosses the boundary 6, he feels haptic feedback informing him of this crossing, for example simulating the pressing of a key. Provision may further be made for a first haptic and/or audio feedback to be generated when a movement of the finger into a closed zone Z1 is detected, and for a second haptic and/or audio feedback to be generated when a movement of the finger out of said closed zone Z1 is detected. The second haptic and/or audio feedback may be distinct from the first haptic and/or audio feedback, so that it is possible to simulate what a user feels by pressing and then releasing a key.

1. A control device for a motor vehicle comprising:
a touch surface intended to detect a contact of a finger of a user and the movement of the finger on the touch surface;
a haptic and/or audio feedback module configured to make the touch surface vibrate and/or to generate audio feedback to the user, in response to a contact on the touch surface; and
a driver unit configured to drive the haptic and/or audio feedback module to generate a haptic and/or audio feedback when movement of the finger is detected across a boundary separating two zones of the touch surface.

2. The control device as claimed in claim 1, wherein no haptic feedback is generated once the finger has crossed the boundary.

3. The control device as claimed in claim 1, wherein the touch surface comprises at least one first zone delimited by a closed surface, and at least one second zone surrounding said at least one first zone.

4. The control device as claimed in claim 3, wherein a first haptic and/or audio feedback is generated when a movement of the finger into the at least one first zone delimited by a closed surface is detected, and a second haptic and/or audio feedback is generated when a movement of the finger out of said at least one first zone is detected.

5. The control device as claimed in claim 4, wherein the second haptic and/or audio feedback is distinct from the first haptic and/or audio feedback.

6. The control device as claimed in claim 1, wherein the driver unit controls a function when contact is detected in the zone situated behind the boundary.

7. The control device as claimed in claim 1, wherein a parameter of the audio feedback is chosen from the intensity of the volume, the phase, the frequency, the duration and/or a parameter of the haptic feedback is chosen from the intensity of the acceleration, the frequency, the amplitude, the duration, the phase.

8. A method for controlling a control device for a motor vehicle as claimed in claim 1, comprising:
detecting a contact of a finger of a user and a movement of the finger on the touch surface; and
generating a haptic and/or audio feedback when the movement of the finger is detected across a boundary separating two zones of the touch surface.

9. The control method as claimed in claim 8, wherein no haptic feedback is generated once the finger has crossed the boundary.

10. The control method as claimed in claim 8, wherein the touch surface comprises at least one first zone delimited by a closed surface, and at least one second zone surrounding said at least one first zone.

11. The control method as claimed in claim 10, further comprising:
generating a first haptic and/or audio feedback when the movement of the finger into the at least one first zone is detected; and
generating a second haptic and/or audio feedback when the movement of the finger out of said at least one first zone is detected.

12. The control method as claimed in claim 11, wherein the second haptic and/or audio feedback is distinct from the first haptic and/or audio feedback.

13. The control method as claimed in claim 8, wherein the driver unit controls a function when contact is detected in the at least one first zone situated behind the boundary.
